(19) United States
(12) Patent Application Publication
(10) Pub. No.: US 2025/0247479 A1
(43) Pub. Date: Jul. 31, 2025

(54) VERIFICATION APPARATUS, VERIFICATION SYSTEM, VERIFICATION METHOD, AND NON-TRANSITORY RECORDING MEDIUM

(71) Applicants: Hirooki Toyama, KANAGAWA (JP); Takashi Sakamaki, KANAGAWA (JP)

(72) Inventors: Hirooki Toyama, KANAGAWA (JP); Takashi Sakamaki, KANAGAWA (JP)

(73) Assignee: Ricoh Company, Ltd., Tokyo (JP)

(21) Appl. No.: 18/797,970

(22) Filed: Aug. 8, 2024

(30) Foreign Application Priority Data
Jan. 30, 2024 (JP) 2024-011520

(51) Int. Cl. H04N 1/00; G06T 7/00

(52) U.S. Cl. CPC H04N 1/00816; G06T 7/0004; H04N 1/00806; H04N 1/00824; G06T 2207/30144; G06T 2207/30168

(57) ABSTRACT

A verification apparatus includes circuitry to acquire print data generated from design data including a variable area and record information included in variable input data, verify data read from the variable area included in the print data to check whether any error exists in the data based on the record information included in the variable input data, and output a verification result based on the verification.

### CROSS-REFERENCE TO RELATED APPLICATIONS

This patent application is based on and claims priority pursuant to 35 U.S.C. § 119(a) to Japanese Patent Application No. 2024-011520, filed on Jan. 30, 2024, in the Japan Patent Office, the entire disclosure of which is hereby incorporated by reference herein.

### BACKGROUND

### Technical Field

The present disclosure relates to a verification apparatus, a verification system, a verification method, and a non-transitory recording medium.

### Related Art

Variable printing is known in the art, in which different contents, such as a postal code and a name of an addressee, are printed on some parts of a printed matter according to the contents of individual records of input data.

A print verification apparatus is also known in the art, which reads a printed matter printed using variable printing by a printing apparatus and compares the read printed matter with individual records of original input data to determine whether printing has been executed correctly.

### SUMMARY

In one aspect, a verification apparatus includes circuitry to acquire print data generated from design data including a variable area and record information included in variable input data, verify data read from the variable area included in the print data to check whether any error exists in the data based on the record information included in the variable input data, and output a verification result based on the verification.

In another aspect, a verification system includes circuitry to acquire print data generated from design data including a variable area and record information included in variable input data, verify data read from the variable area included in the print data to check whether any error exists in the data based on the record information included in the variable input data, and output a verification result based on the verification.

In another aspect, a verification method includes acquiring print data generated from design data including a variable area and record information included in variable input data, verifying data read from the variable area included in the print data to check whether any error exists in the data based on the record information included in the variable input data, and outputting a verification result based on the verification.

In another aspect, a non-transitory recording medium stores a plurality of program codes which, when executed by one or more processors, causes the one or more processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a configuration of a verification system according to an embodiment of the present disclosure;

FIG. 2 is a diagram illustrating an overview of the process according to an embodiment of the present disclosure;

FIG. 3 is a block diagram illustrating a hardware configuration of a computer according to an embodiment of the present disclosure;

FIG. 4 is a block diagram illustrating a functional configuration of a verification apparatus according to an embodiment of the present disclosure;

FIG. 5 is a flowchart of the process executed by a verification system according to an embodiment of the present disclosure;

FIG. 6 is a diagram illustrating a user interface (UI) screen according to an embodiment of the present disclosure;

FIG. 7 is a diagram illustrating variable input data according to an embodiment of the present disclosure;

FIG. 8 is a diagram illustrating another type of variable input data according to an embodiment of the present disclosure;

FIG. 9 is a flowchart of the verification process according to the first embodiment of the present disclosure;

FIG. 10 is a diagram illustrating a verification result according to the first embodiment of the present disclosure;

FIG. 11 is a diagram illustrating a display screen on which a verification result is displayed, according to the first embodiment of the present disclosure;

FIG. 12 is a diagram illustrating another display screen on which a verification result is displayed, according to the first embodiment of the present disclosure;

FIG. 13 is a flowchart of the verification process according to the second embodiment of the present disclosure;

FIG. 14 is a diagram illustrating a display screen on which a verification result is displayed, according to the second embodiment of the present disclosure;

FIG. 15 is a diagram illustrating another display screen on which a verification result is displayed, according to the second embodiment of the present disclosure;

FIG. 16 is a diagram illustrating a UI screen according to the third embodiment of the present disclosure;

FIG. 17 is a diagram illustrating a setting screen for imposition information according to an embodiment of the present disclosure;

FIG. 18 is a diagram illustrating another setting screen for imposition information according to an embodiment of the present disclosure;

FIG. 19 is a diagram illustrating an overview of the process according to the fourth embodiment of the present disclosure;

FIGS. 20A and 20B are diagrams each illustrating data according to the fourth embodiment of the present disclosure;

FIG. 21 is a flowchart of the process executed by a verification system according to the fourth embodiment of the present disclosure; and

FIG. 22 is a flowchart of the verification process according to the fourth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings.

### Configuration of System

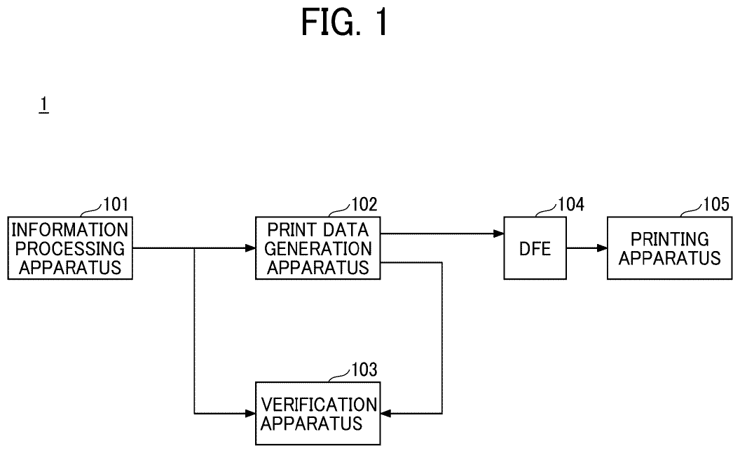

FIG. 1 is a block diagram illustrating a configuration of a verification system 1 according to an embodiment of the present disclosure. The verification system 1 is a system that verifies print data used for variable printing. The variable printing is printing of different contents on some parts of a printed matter, such as a postal code and a name of an addressee, according to the contents of individual records of input data. As illustrated in FIG. 1, the verification system 1 includes an information processing apparatus 101, a print data generation apparatus 102, a verification apparatus 103, a digital front end (DFE) 104, and a printing apparatus 105. Alternatively, the information processing apparatus 101, the DFE 104, and the printing apparatus 105 may be apparatuses external to the verification system 1 including the print data generation apparatus 102 and the verification apparatus 103.

The information processing apparatus 101 is a computer communicably connected to the print data generation apparatus 102 and the verification apparatus 103. The information processing apparatus 101 serves as a communication terminal used by a client who requests variable printing according to the present embodiment. In this case, the information processing apparatus 101 transmits a submitted manuscript used for executing the variable printing to, for example, the print data generation apparatus 102.

In another embodiment, the information processing apparatus 101 may serve as a server apparatus that manages a submitted manuscript used for executing the variable printing. In such a case, the print data generation apparatus 102 acquires, as needed, a submitted manuscript used for executing the variable printing from the information processing apparatus 101.

The submitted manuscript used for executing the variable printing includes, for example, design data and variable input data. The design data is data used for printing common parts in the variable printing. The design data is, for example, image data such as data described in the portable document format (PDF), but is not limited thereto. The data described in the PDF may be referred to as a “PDF file” in the following description. The variable input data is data used for printing variable parts in the variable printing. The variable input data is, for example, text data such as data described in the comma-separated values (CSV) format. The data described in the CSV format may be referred to as a “CSV file” in the following description.

The print data generation apparatus 102 is, for example, a computer communicably connected to the information processing apparatus 101, the verification apparatus 103, and the DFE 104 (or the printing apparatus 105). The print data generation apparatus 102 generates print data (e.g., a PDF file) used for the variable printing based on the submitted manuscript acquired from the information processing apparatus 101.

The verification apparatus 103 collates the print data used for the variable printing generated by the print data generation apparatus 102 with the variable input data acquired from the information processing apparatus 101 to check whether any error exists in the print data before printing is executed.

The DFE 104 is an information processing apparatus that executes the raster image processor (RIP) processing to convert the print data generated by the print data generation apparatus 102 into a raster image printable by the printing apparatus 105. The printing apparatus 105 is an image forming apparatus that executes printing on a sheet serving as a recording medium based on the data generated by the DFE 104. In the present embodiment, the DFE 104 and the printing apparatus 105 may have any configuration as long as printing is executed based on the print data generated by the print data generation apparatus 102.

For example, some or all of the functions of the DFE 104 may be included in the printing apparatus 105 or the print data generation apparatus 102. Further, the printing apparatus 105 may be connected to a print verification apparatus that verifies a printed matter or a post-processing apparatus such as a stacker that stacks a printed matter printed by the printing apparatus 105 on a tray.

### Overview of Process

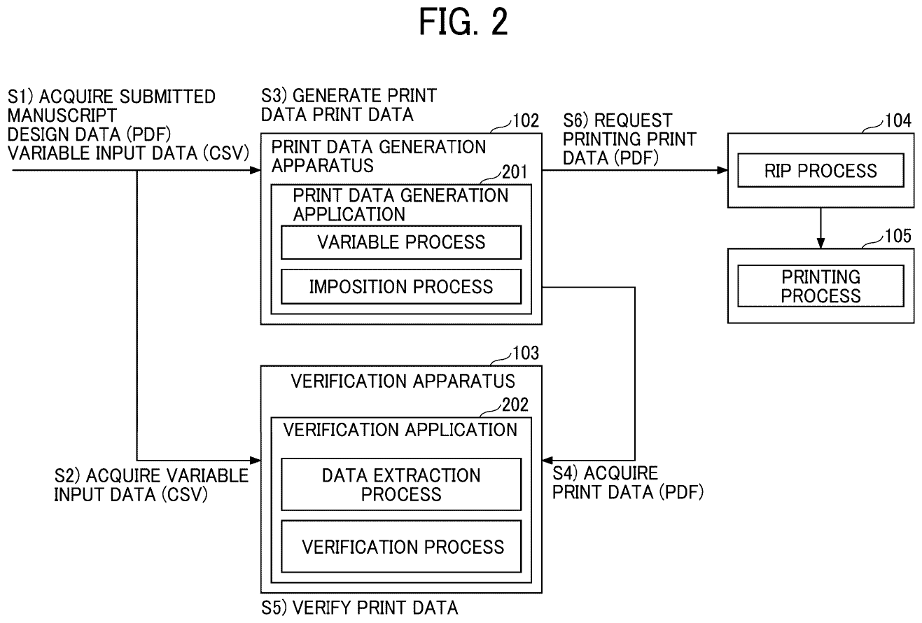

FIG. 2 is a diagram illustrating an overview of the process according to an embodiment of the present disclosure. The print data generation apparatus 102 acquires, for example, a submitted manuscript that includes design data (a PDF file) including a variable area and variable input data (a CSV file) (step S1). The verification apparatus 103 acquires the variable input data (CSV file) included in the submitted manuscript (step S2).

The print data generation apparatus 102 generates print data (another PDF file) used for variable printing from the acquired design data (PDF file) including the variable area and record information included in the variable input data (CSV file) (step S3). For example, an operator uses an application program for generating print data (referred to as a print data generation application 201 in the following description) installed in the print data generation apparatus 102 to set the design, imposition, variable area, and the like. In response to the operation performed by the operator, the print data generation application 201 executes, for example, a variable process and an imposition process, and generates print data (another PDF) used for the variable printing. In the present embodiment, the print data generation application 201 executed by the print data generation apparatus 102 may be an existing application.

The verification apparatus 103 acquires the print data (the other PDF file) used for the variable printing generated by the print data generation apparatus 102 (step S4). The verification apparatus 103 also verifies the data read from the variable area included in the acquired print data (the other PDF file) to check whether any error exists in the data based on the record information included in the variable input data (CSV file) (step S5). For example, the operator uses a verification application program (referred to as a verification application 202 in the following description) installed in the verification apparatus 103 to set a variable area and associate the variable area with the variable input data. In response to the operation performed by the operator, the verification application 202 executes, for example, a data extraction process to extract record information from the variable area included in the print data and a verification process to verify the consistency between the record information included in the variable input data and the extracted record information, and outputs a verification result.

In the case where the verification result is determined to be “PASS,” which indicates that there is no issue with the consistency, the print data generation apparatus 102 transmits a print request that includes the generated print data (the other PDF file) to the DFE 104 (step S6).

According to the technique in the comparative example, for example, even when an error exists in print data due to an incorrect setting for variable printing, the error cannot be detected until after printing has been executed.

Through the processes described above, the verification system 1 according to the present embodiment verifies print data used for variable printing to check whether any error exists in the print data before printing is executed. The configuration of the verification system 1 illustrated in FIG. 1 is given by way of example. For example, some or all of the functions of the verification apparatus 103 may be included in the print data generation apparatus 102, the DFE 104, or the like.

### Hardware Configurations

### Hardware Configuration of Verification Apparatus

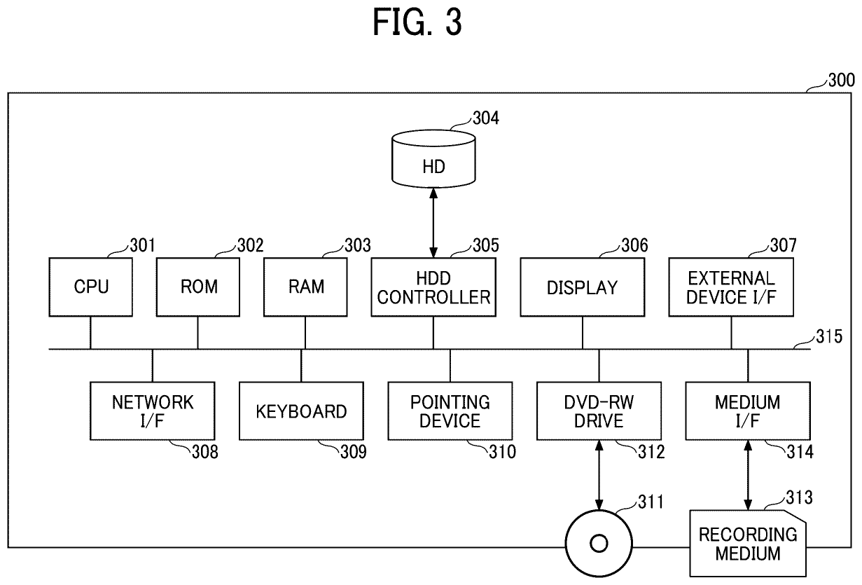

The verification apparatus 103 has, for example, a hardware configuration of a computer 300 as illustrated in FIG. 3. The information processing apparatus 101, the print data generation apparatus 102, and the DFE 104 also have the hardware configuration of the computer 300.

FIG. 3 is a block diagram illustrating a hardware configuration of the computer 300 according to an embodiment of the present disclosure. As illustrated in FIG. 3, the computer 300 includes, for example, a central processing unit (CPU) 301, a read-only memory (ROM) 302, a random-access memory (RAM) 303, a hard disk (HD) 304, a hard disk drive (HDD) controller 305, a display 306, an external device interface (I/F) 307, a network I/F 308, a keyboard 309, a pointing device 310, a digital versatile disc-rewritable (DVD-RW) drive 312, a medium I/F 314, and a bus line 315.

The CPU 301 controls the entire operation of the computer 300. The ROM 302 stores, for example, a program such as an initial program loader (IPL) used to boot the computer 300. The RAM 303 is used as, for example, a work area for the CPU 301. The HD 304 stores, for example, programs such as an operating system (OS), an application, and a device driver, and various data. The HDD controller 305 controls, for example, the reading and writing of various data from and to the HD 304 under the control of the CPU 301. The HD 304, which operates with the HDD controller 305, is given by way of example as a storage device provided with the computer 300.

The display 306 displays various information such as a cursor, a menu, a window, characters, and images. The display 306 may be provided separately from the computer 300. The external device I/F 307 is an interface circuit for connecting various external devices such as an external memory to the computer 300. The network I/F 308 is an interface circuit that connects the computer 300 to a communication network to enable communication with other devices.

The keyboard 309 serves as an input device provided with a plurality of keys used for, for example, inputting characters, numerical values, and various instructions. The pointing device 310 serves as an input device used for, for example, selecting or executing various instructions, selecting an object to be processed, and moving a cursor being displayed. The keyboard 309 and the pointing device 310 may be provided separately from the computer 300.

The DVD-RW drive 312 controls the reading and writing of various data from and to a DVD-RW 311, which serves as a removable recording medium according to the present embodiment. The DVD-RW 311 is not limited to the DVD-RW, and may be another type of removable recording medium. The medium I/F 314 controls the reading and writing (storing) of data from and to a recording medium 313 such as a flash memory. Examples of the bus line 315 include, but are not limited to, an address bus, a data bus, and various control signal lines, which electrically connect the above-described components.

### Functional Configuration

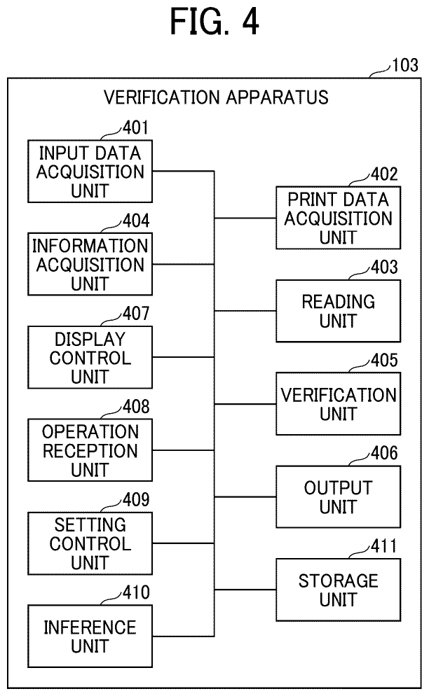

FIG. 4 is a block diagram illustrating a functional configuration of the verification apparatus 103 according to an embodiment of the present disclosure. The verification apparatus 103 implements the functional units illustrated in FIG. 4 by the CPU 301 executing a predetermined program such as the verification application 202. As illustrated in FIG. 4, the verification apparatus 103 includes, for example, an input data acquisition unit 401, a print data acquisition unit 402, a reading unit 403, an information acquisition unit 404, a verification unit 405, an output unit 406, a display control unit 407, an operation reception unit 408, a setting control unit 409, and an inference unit 410. In some embodiments, at least a part of the functional units described above may be implemented by hardware such as a circuit.

The verification apparatus 103 also includes a storage unit 411, which is implemented by, for example, a storage device such as the HD 304 operating under the control of the HDD controller 305.

The input data acquisition unit 401 executes an input data acquisition process to acquire variable input data from, for example, a submitted manuscript including design data and variable input data, which is input to the print data generation apparatus 102. The input data acquisition unit 401 may acquire the variable input data from the information processing apparatus 101 or the print data generation apparatus 102.

The print data acquisition unit 402 executes a print data acquisition process to acquire print data generated from the design data that includes a variable area and record information included in the variable input data. For example, the print data acquisition unit 402 acquires, from the print data generation apparatus 102, the print data used for the variable printing generated by the print data generation apparatus 102 based on the submitted manuscript. The variable area is an area in the print data, in which the print content varies for an individual printed matter, such as a postal code, an address, or a name. The variable input data is data (for example, a character string) that is printed in a variable area and that varies for an individual printed matter, such as a postal code, an address, or a name.

The reading unit 403 executes a reading process to read record information from the variable area included in the print data acquired by the print data acquisition unit 402. For example, when the print data is a PDF file and a character string such as a postal code, an address, or a name is included in the variable area, the reading unit 403 acquires the character string (text data) included in the variable area from the PDF file. When the print data is image data that does not include text data, the reading unit 403 may use, for example, the optical character recognition (OCR) processing to read the text data from a character image (i.e., an image including a character string) of the variable area.

When a two-dimensional code such as a QUICK RESPONSE (QR) CODE in which the record information included in the variable input data is encoded is printed in a variable area, the reading unit 403 may decode the two-dimensional code included in the variable area to read the record information.

The information acquisition unit 404 executes an information acquisition process to acquire record information from the variable input data. For example, when the variable input data is a CSV file described in the CSV format, the information acquisition unit 404 acquires a record corresponding to the variable area included in the print data from the variable input data. The CSV file includes one or more records, and each record is separated by a line feed. Each record includes one or more pieces of record information (items), and each piece of record information is separated by a comma. The variable input data may be described in a format other than the CSV format.

The verification unit 405 executes a verification process to verify the data read from the variable area included in the print data acquired by the print data acquisition unit 402 to check whether any error exists in the data based on the record information included in the variable input data. For example, the verification unit 405 verifies the consistency between the record information included in the variable input data acquired by the information acquisition unit 404 and the record information read by the reading unit 403 from the variable area included in the print data. For example, in the case where the record information included in the variable input data and the record information read from the variable area are determined to match, the verification unit 405 determines the verification result to be “PASS.” In the case where the record information included in the variable input data and the record information read from the variable area are determined not to match, the verification unit 405 determines the verification result to be “FAIL.”

The output unit 406 executes an output process to output the verification result determined by the verification unit 405. For example, the output unit 406 may output the verification result to the storage unit 411 or another device, or may cause the display control unit 407 to control a display such as the display 306 to display (output) the verification result. Alternatively, the output unit 406 may output the verification result to, for example, the print data generation apparatus 102 or an external apparatus such as a server.

The display control unit 407 executes a display control process to control the display of various display screens. For example, the display control unit 407 controls a display such as the display 306 to display a user interface (UI) screen, a display screen of a verification result, and the like, which will be described later. The operation reception unit 408 executes an operation reception process to receive an operation to the display screen caused to be displayed by the display control unit 407.

The setting control unit 409 executes a setting control process to control a setting such as a setting of a variable area, association of the variable area with variable input data, and a setting of imposition, which will be described later. The setting control unit 409 also executes a process to reflect (copy) the setting of the variable area set for the image of one printed matter among the images of multiple printed matters that are imposed in the acquired print data to the images of the rest of the multiple printed matters.

In the case where an error is detected in the data read from the variable area included in the print data, the inference unit 410 executes an inference process to infer the cause of the error.

The storage unit 411 stores various information or data including, for example, variable input data acquired by the input data acquisition unit 401, print data acquired by the print data acquisition unit 402, a verification result determined by the verification unit 405, and setting information managed by the setting control unit 409.

The functional configuration of the verification apparatus 103 illustrated in FIG. 4 is given by way of example. For example, some or all of the functions of the verification apparatus 103 illustrated in FIG. 4 may be included in the print data generation apparatus 102, the DFE 104, or the like. Furthermore, the functional units of the verification apparatus 103 may be allocated to multiple apparatuses. In other words, it is sufficient that one or more apparatuses included in the verification system 1 include the functional units of the verification apparatus 103 illustrated in FIG. 4.

### Process Flow

The process flow of the verification method according to the present embodiment is described below.

### Process Executed by Verification System

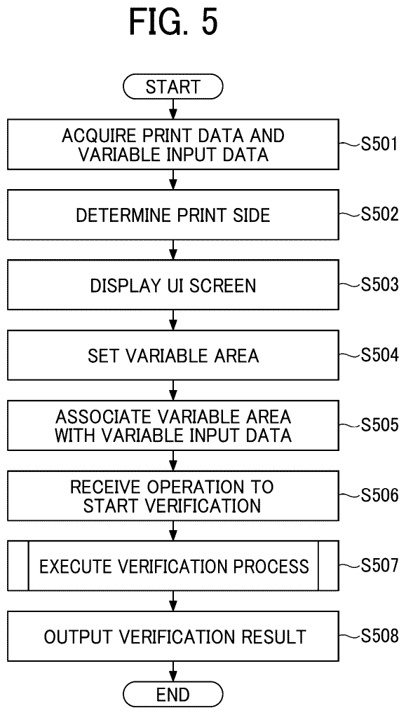

FIG. 5 is a flowchart of the process executed by the verification system 1 according to an embodiment of the present disclosure. This process is given by way of example as the process executed by the verification apparatus 103 that includes, for example, the functional units described with reference to FIG. 4.

In step S501, the verification apparatus 103 acquires the print data generated by the print data generation apparatus 102 and the variable input data used for generating the print data. For example, the operator selects the print data subjected to verification and the variable input data used for generating the print data on the reading screen caused to be displayed by the display control unit 407. In this way, the verification apparatus 103 reads the print data and the variable input data selected by the operator.

In step S502, the verification apparatus 103 determines a print side (single-sided or double-sided). For example, the verification apparatus 103 displays a selection screen for selecting whether the print data is print data in a double-sided printing format or print data in a single-sided printing format, and receives a selection operation performed by the operator.

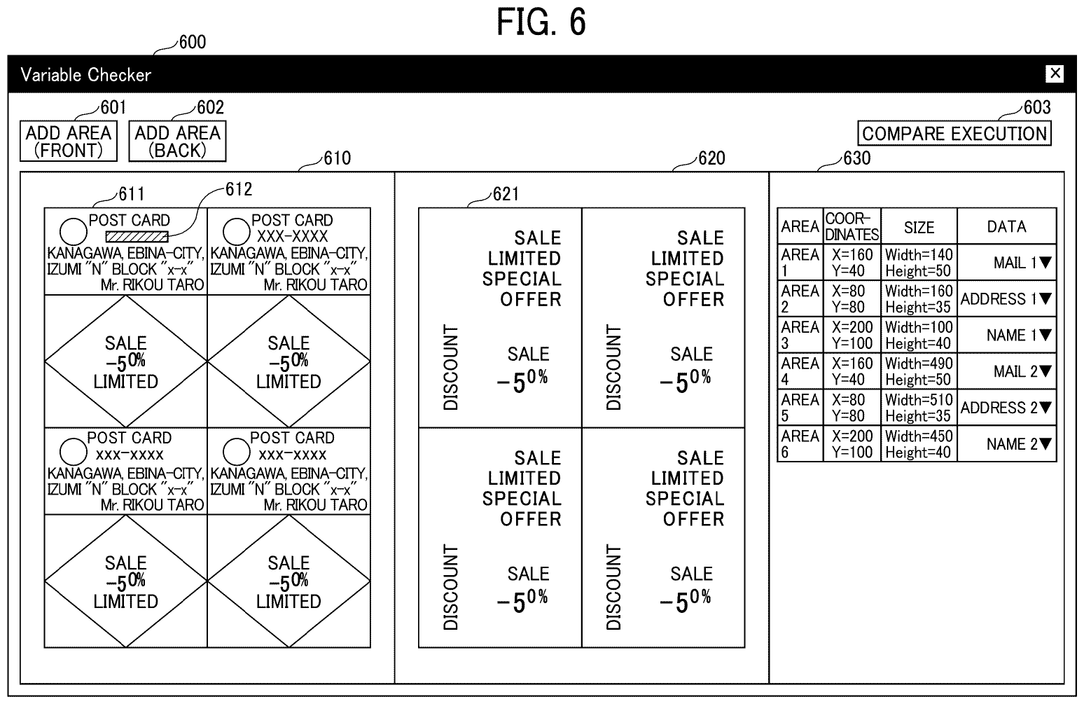

In step S503, the verification apparatus 103 displays a UI screen on which a preview image when printing is executed based on the acquired print data is displayed. For example, in the case where the print side is double-sided, the display control unit 407 controls a display such as the display 306 to display a UI screen 600 as illustrated in FIG. 6.

FIG. 6 is a diagram illustrating the UI screen 600 according to an embodiment of the present disclosure. As illustrated in FIG. 6, for example, a front side preview image 610 of the print data (i.e., a preview image of the print data to be printed on the front side), a back side preview image 620 of the print data (i.e., a preview image of the print data to be printed on the back side), and an area data association table 630 are displayed on the UI screen 600. On the UI screen 600, an “ADD AREA (FRONT)” button 601, an “ADD AREA (BACK)” button 602, and a “COMPARE EXECUTION” button 603 are also displayed. In the case where the print side is single-sided, the back side preview image 620 and the “ADD AREA (BACK)” button 602 are not displayed on the UI screen 600.

As illustrated in FIG. 6, front side images 611 of four printed matters that are imposed are presented on the front side preview image 610. Similarly, back side images 621 of the four printed matters that are imposed are presented on the back side preview image 620.

In step S504, the verification apparatus 103 sets a variable area. For example, when the operator selects the “ADD AREA (FRONT)” button 601 on the UI screen 600, a variable area can be set on the front side preview image 610. For example, the operator performs a drag operation or a drag and drop operation from the coordinates of an upper left point to the coordinates of a lower right point on the front side preview image 610 to designate a variable area 612. When the variable area 612 is designated by the operator, the verification apparatus 103 adds the information of the variable area designated by the operator to the area data association table 630 on the UI screen 600.

As illustrated in FIG. 6, the area data association table 630 includes pieces of information such as an “AREA,” “COORDINATES,” a “SIZE,” and “DATA” as data items. The “AREA” is information such as the name of an area or the identification (ID) of an area for identifying a variable area. The “COORDINATES” and “SIZE” are information indicating the coordinates and the size of the variable area designated by the operator, respectively. The “DATA” is information indicating data corresponding to an individual variable area, and the operator can select the data using, for example, a pull-down menu.

When multiple variable areas exist, the operator can add the multiple variable areas to the area data association table 630 by repeatedly performing a similar operation.

Alternatively, the verification apparatus 103 may, for example, cooperate with the print data generation apparatus 102 to set a variable area by acquiring information on the variable area set on the print data generation apparatus 102 from the print data generation apparatus 102.

In step S505, the verification apparatus 103 associates the set variable area with the variable input data. For example, the operator can set data to be associated with an individual variable area using a pull-down menu of the “DATA” in the area data association table 630.

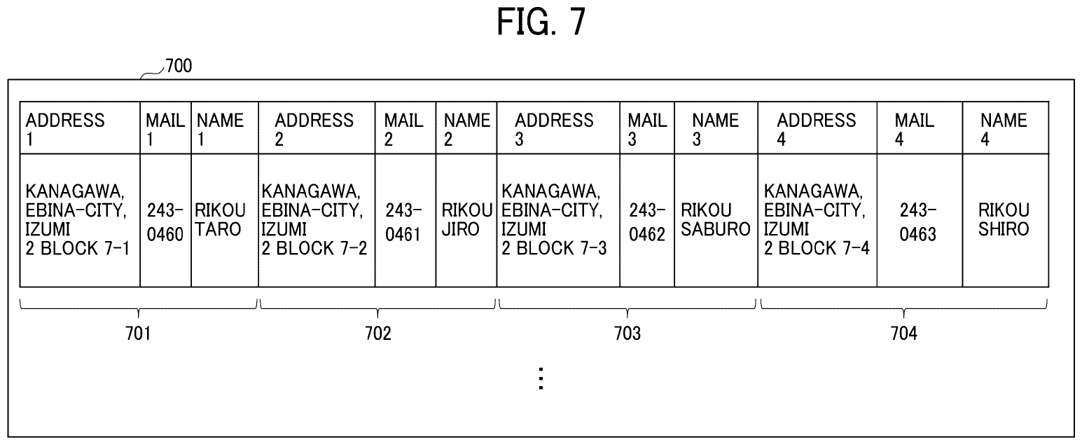

FIG. 7 is a diagram illustrating variable input data 700 according to an embodiment of the present disclosure. As illustrated in FIG. 7, the variable input data 700 includes four records 701, 702, 703, and 704 in one row. Each record includes three pieces of record information such as an address, a mail (postal code), and a name.

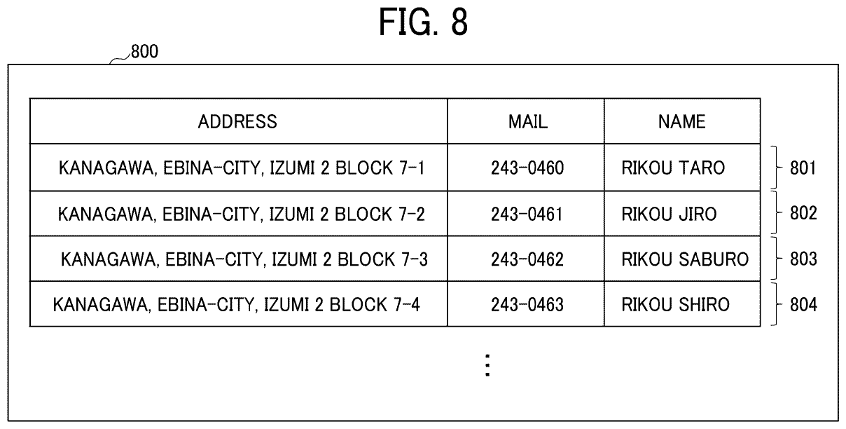

In this case, as illustrated in FIG. 6, by setting a “MAIL 1” to the data corresponding to a variable area “AREA 1” in the area data association table 630, the variable area “AREA 1” and the record information “MAIL 1” of a record 701 are associated with each other. FIG. 8 is a diagram illustrating variable input data 800 as another type of variable input data according to an embodiment of the present disclosure. As illustrated in FIG. 8, the variable input data 800 includes four records 801, 802, 803, and 804. Each record includes three pieces of record information such as an address, a mail (postal code), and a name.

In this case, the record information “ADDRESS” of a record 801 corresponds to an “ADDRESS 1,” the record information “MAIL” corresponds to the “MAIL 1,” and the record information “NAME” corresponds to a “NAME 1.” Similarly, the record information “ADDRESS” of a record 802 corresponds to an “ADDRESS 2,” the record information “MAIL” corresponds to a “MAIL 2,” and the record information “NAME” corresponds to a “NAME 2.” The same applies to a record 803 and subsequent records. Accordingly, for example, as illustrated in FIG. 6, by setting the “MAIL 1” to the data corresponding to the variable area “AREA 1” in the area data association table 630, the variable area “AREA 1” and the “MAIL” of the record 801 are associated with each other.

In steps S506 and S507, in response to receiving an operation to start verification, the verification apparatus 103 executes a verification process to verify the consistency between the record information included in the variable input data and the record information read from the variable area included in the print data.

In step S508, the verification apparatus 103 outputs a verification result of the verification process.

### Verification Process

An example case in which the verification process executed by the verification apparatus 103 in step S507 of FIG. 5 is described below.

### First Embodiment

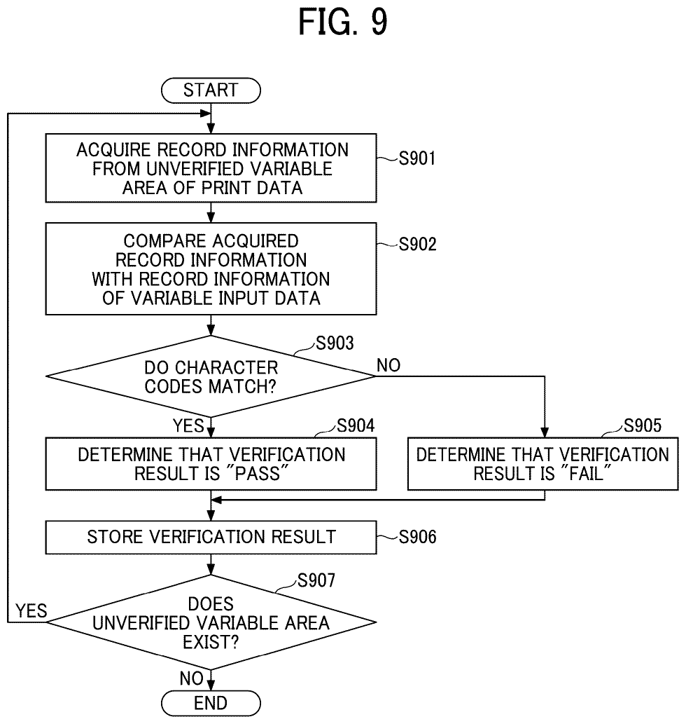

FIG. 9 is a flowchart of the verification process according to the first embodiment of the present disclosure. This process is given by way of example as the verification process executed by the verification apparatus 103 in step S507 of FIG. 5.

In step S901, the verification apparatus 103 acquires record information from a variable area that has not been verified (an unverified variable area) included in the print data.

In step S902, the verification apparatus 103 compares the acquired record information with the record information included in the variable input data. For example, as illustrated in FIG. 6, it is assumed that the “MAIL 1” is set to the data corresponding to the variable area “AREA 1” in the area data association table 630. In this case, the verification apparatus 103 compares the record information acquired from the variable area “AREA 1” with the record information acquired from the “MAIL 1” of the variable input data 700 or the “MAIL” of the record 801 of the variable input data 800.

For example, in step S903, the verification apparatus 103 compares the record information acquired from the variable area with the record information included in the variable input data to determine whether the character codes match. In the case where the character codes are determined to match, the process executed by the verification apparatus 103 proceeds to step S904. On the other hand, in the case where the character codes are determined not to match, the process executed by the verification apparatus 103 proceeds to step S905.

When the process proceeds to step S904, the verification apparatus 103 determines that the verification result is “PASS” (no issue). On the other hand, when the process proceeds to step S905, the verification apparatus 103 determines that the verification result is “FAIL” (an issue). In step S906, the verification apparatus 103 stores the verification result in, for example, the storage unit 411.

In step S907, the verification apparatus 103 determines whether any unverified variable area exists. In the case where an unverified variable area is determined to exist, the process executed by the verification apparatus 103 returns to step S901. On the other hand, in the case where an unverified variable area is determined not to exist, the process of FIG. 9 executed by the verification apparatus 103 ends.

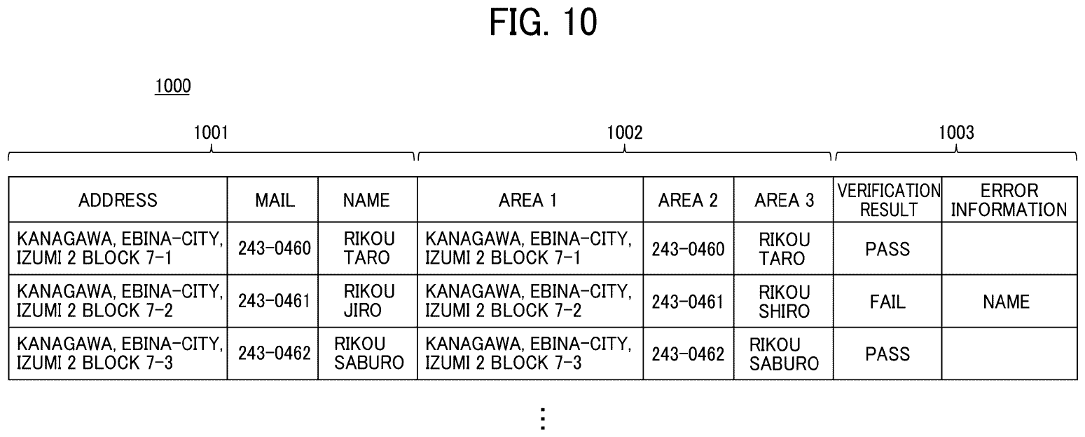

Through the process of FIG. 9, the verification apparatus 103 creates, for example, a verification result 1000 as illustrated in FIG. 10.

FIG. 10 is a diagram illustrating the verification result 1000 according to the first embodiment of the present disclosure. As illustrated in FIG. 10, in the verification result 1000, record information (“ADDRESS,” “MAIL,” “NAME”) 1001 acquired from the variable input data, record information (“AREA 1,” “AREA 2,” “AREA 3”) 1002 acquired from the variable area, and a verification result 1003 are included. Further, as illustrated in FIG. 10, in addition to the verification result (PASS or FAIL), “ERROR INFORMATION” for specifying record information for which the verification result is determined to be “FAIL” is included in the verification result 1000.

For example, in step S508 of FIG. 5, the verification apparatus 103 outputs the verification result 1000 to the storage unit 411, the display screen of the verification apparatus 103, the print data generation apparatus 102, or the like.

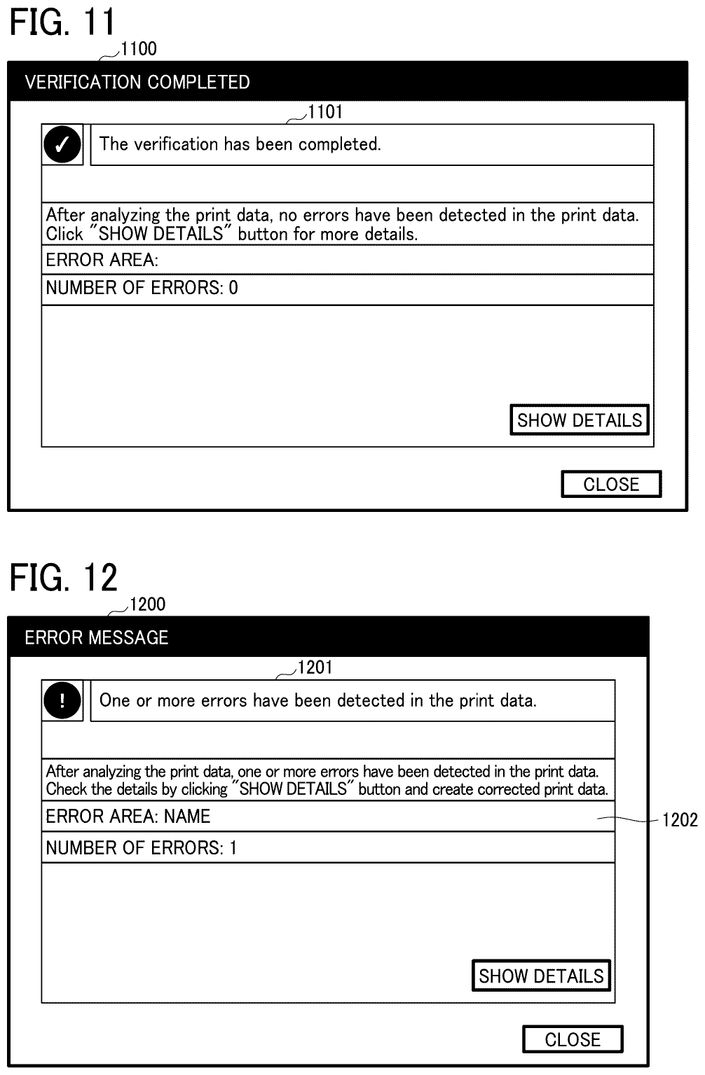

Preferably, when no error is detected in the print data, the verification apparatus 103 displays, for example, a verification result display screen 1100 as illustrated in FIG. 11. As illustrated in FIG. 11, on the verification result display screen 1100, a verification result 1101 indicating that no error is detected in the print data is displayed. On the other hand, when an error is detected in the print data, the verification apparatus 103 displays, for example, a verification result display screen 1200 as illustrated in FIG. 12. As illustrated in FIG. 12, for example, a verification result 1201 indicating that an error is detected in the print data and information 1202 indicating an error area where the error is detected are displayed on the verification result display screen 1200.

As described above, according to the verification apparatus 103 of the first embodiment, an error in print data used for variable printing can be detected before printing is executed.

### Second Embodiment

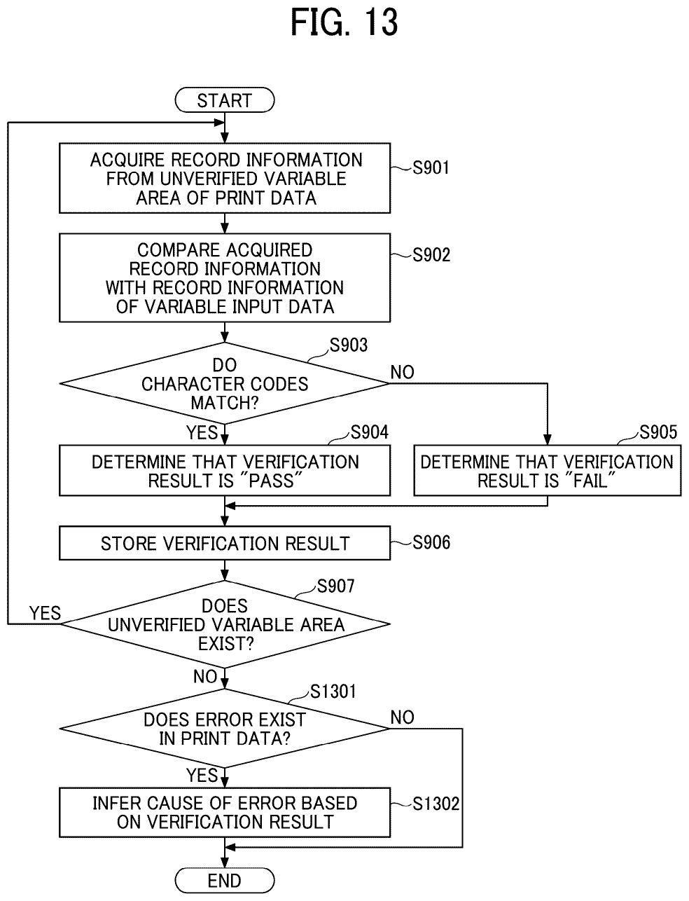

FIG. 13 is a flowchart of the verification process according to the second embodiment of the present disclosure. This process is given by way of example as another verification process executed by the verification apparatus 103 in step S507 of FIG. 5. Among the processes in FIG. 13, the processes in steps S901 to S907 are substantially the same as those of the verification process according to the first embodiment described with reference to FIG. 9, and redundant descriptions thereof are omitted below to simplify the description.

In step S1301, the verification apparatus 103 checks whether any error exists in the print data based on the verification result determined through steps S901 to S907. In the case where an error is detected in the print data, the process executed by the verification apparatus 103 proceeds to step S1302. On the other hand, in the case where no error is detected in the print data, the process of FIG. 13 executed by the verification apparatus 103 ends.

When the process proceeds to step S1302, the verification apparatus 103 executes an inference process to infer a cause of the occurrence of the error based on the verification result determined through steps S901 to S907.

For example, in the case where an error exists in the imposition order, it is assumed that the order of arrangement of multiple printed matters existing in one page of print data is incorrect. As a result, “FAIL” is repeatedly presented for one or more of multiple records corresponding to the one page of the print data. For example, in the case of print data in which four printed matters are imposed, if the verification result is “PASS” for the first and fourth printed matters but the verification result is repeatedly “FAIL” for the second and third printed matters, it is highly likely that the imposition order is incorrect.

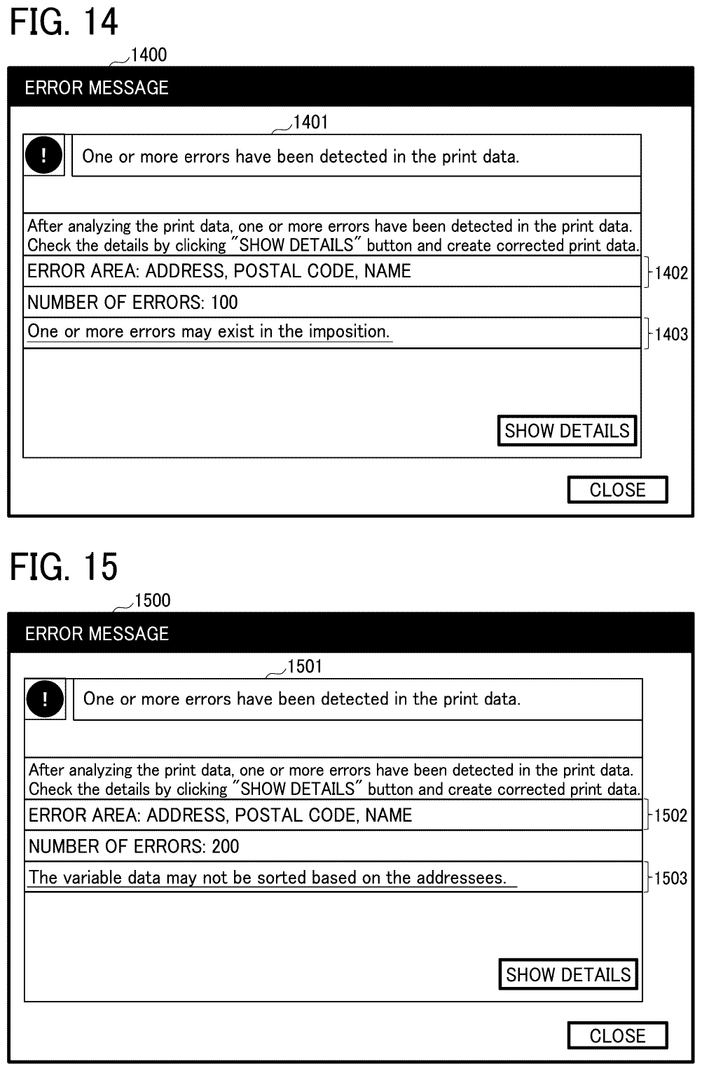

Accordingly, in the case where “FAIL” is repeatedly presented for the record information of a specific position of the imposition in the verification result of the print data in which the imposition is executed, the inference unit 410 of the verification apparatus 103 infers that the cause of the error is an incorrectness of the imposition order. In this case, the verification apparatus 103 displays, for example, a verification result display screen 1400 as illustrated in FIG. 14. As illustrated in FIG. 14, for example, a verification result 1401 indicating that an error is detected in the print data, information 1402 indicating an error area where the error is detected, and information 1403 indicating that the inference result obtained by inferring the cause of the error is “an incorrectness of the imposition order” are displayed on the verification result display screen 1400.

As another example, in the case where an error exists in the sort order, the verification result is “PASS” for up to a certain record, and is “FAIL” for all the records from the record in which an error of the order occurs in many cases. Accordingly, in the case where “FAIL” is consecutively presented for a predetermined number of records or more from a certain record in the verification result of the print data, the inference unit 410 of the verification apparatus 103 infers that the cause of the error is an incorrectness of the sort order. In this case, the verification apparatus 103 displays, for example, a verification result display screen 1500 as illustrated in FIG. 15. As illustrated in FIG. 15, for example, a verification result 1501 indicating that an error is detected in the print data, information 1502 indicating an error area where the error is detected, and information 1503 indicating that the inference result obtained by inferring the cause of the error is “an incorrectness of the sort order” are displayed on the verification result display screen 1500.

Alternatively, the verification apparatus 103 may infer the cause of the error using, for example, a machine learning model or the like that has been trained in advance by machine learning, with the verification result determined through steps S901 to S907 as an explanatory variable and the cause of the error as an objective variable.

In this way, the verification apparatus 103 verifies the print data used for the variable printing to check whether any error exists in the print data before printing is executed. In the case where an error is detected in the print data, the verification apparatus 103 may output an inference result obtained by inferring the cause of the error.

### Third Embodiment

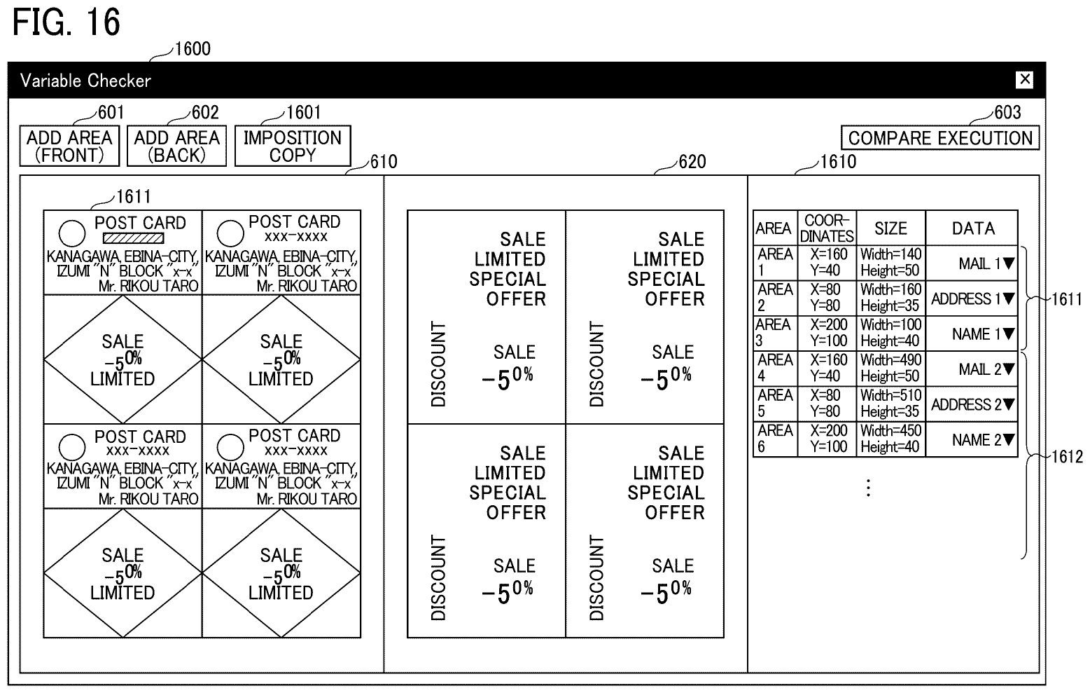

In the third embodiment, another example of a UI screen displayed by the verification apparatus 103 is described. FIG. 16 is a diagram illustrating a UI screen 1600 according to the third embodiment of the present disclosure. As illustrated in FIG. 16, the UI screen 1600 according to the third embodiment is different from the UI screen 600 described with reference to FIG. 6 in that an “IMPOSITION COPY” button 1601 is added.

In using the UI screen 600 described with reference to FIG. 6, when the print data is print data in which multiple printed matters are imposed, the operation to set a variable area needs to be repeatedly executed for each printed matter by the number of impositions.

In using the UI screen 1600 according to the third embodiment, by selecting the “IMPOSITION COPY” button 1601, the setting of the variable area set for an image 1611 of one printed matter among images of multiple printed matters can be reflected to the images of the rest of the multiple printed matters. For example, the setting control unit 409 of the verification apparatus 103 calculates, based on the setting information of the variable area set for the image 1611 of the one printed matter, the coordinates of a position relative to the image 1611 of the one printed matter for each of the images of the rest of the multiple printed matters that are imposed. Further, the setting control unit 409 automatically sets setting information 1612 of the variable area for each of the images of the rest of the multiple printed matters based on the calculation result of the coordinates of the position relative to the image 1611 of the one printed matter.

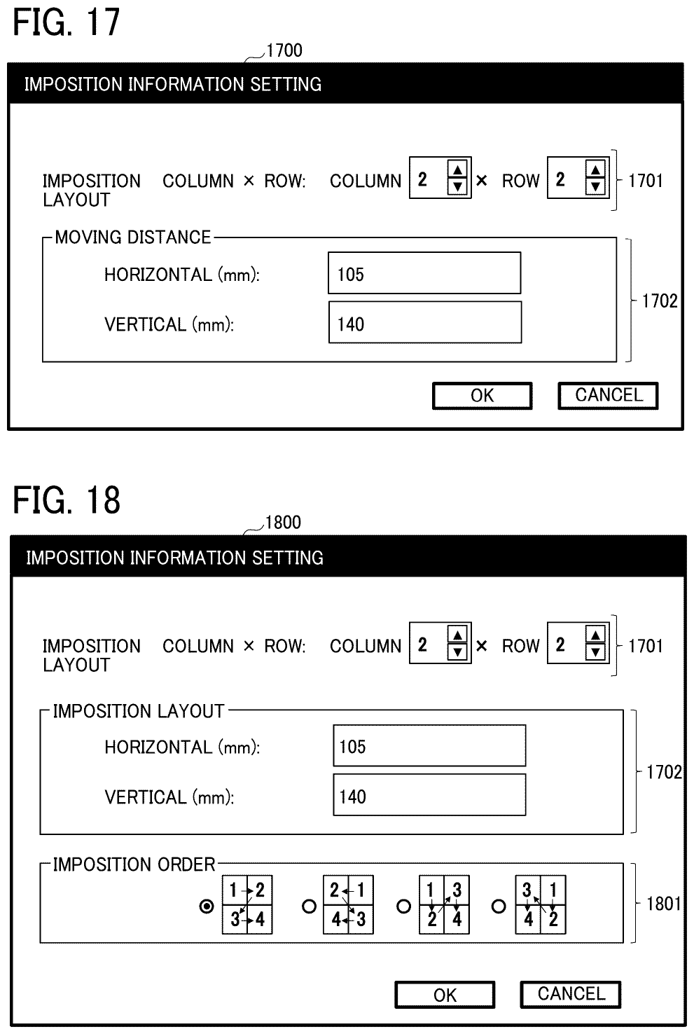

For example, the setting control unit 409 displays an imposition information setting screen 1700 as illustrated in FIG. 17 to receive an imposition layout setting 1701 and a moving distance setting 1702. The operator uses the imposition layout setting 1701 to set the number of columns and rows for the imposition. The operator also uses the moving distance setting 1702 to set the horizontal and vertical distances between the multiple printed matters that are imposed. In this case, it is assumed that the imposition order is determined in advance.

As another example, the setting control unit 409 may display an imposition information setting screen 1800 as illustrated in FIG. 18 to receive an imposition order setting 1801 in addition to the imposition layout setting 1701 and the moving distance setting 1702. The operator uses the imposition order setting 1801 to set the imposition order for the multiple printed matters that are imposed.

For example, the setting control unit 409 calculates, based on the information set on the imposition information setting screen 1700 or 1800, the coordinates of a position relative to the image 1611 of the one printed matter for each of the images of the rest of the multiple printed matters that are imposed.

### Fourth Embodiment

In each of the above-described embodiments, the verification apparatus 103 verifies the consistency between the record information included in the variable input data and the record information read from the variable area included in the print data. However, each of the above-described embodiments is merely an example, and each of the above-described embodiments can be modified or applied in various ways.

In the fourth embodiment, a case is described in which the verification apparatus 103 verifies the consistency between data corresponding to record information included in variable input data and data read from a variable area of print data.

In recent years, direct mail sent by companies to customers is becoming increasingly personalized. For example, a system that sends a direct mail including advertisement contents appropriate to a customer to whom the direct mail is sent in accordance with the preference of the customer is widespread.

The verification system 1 according to the present embodiment can also verify personalized data included in the variable area included in the print data.

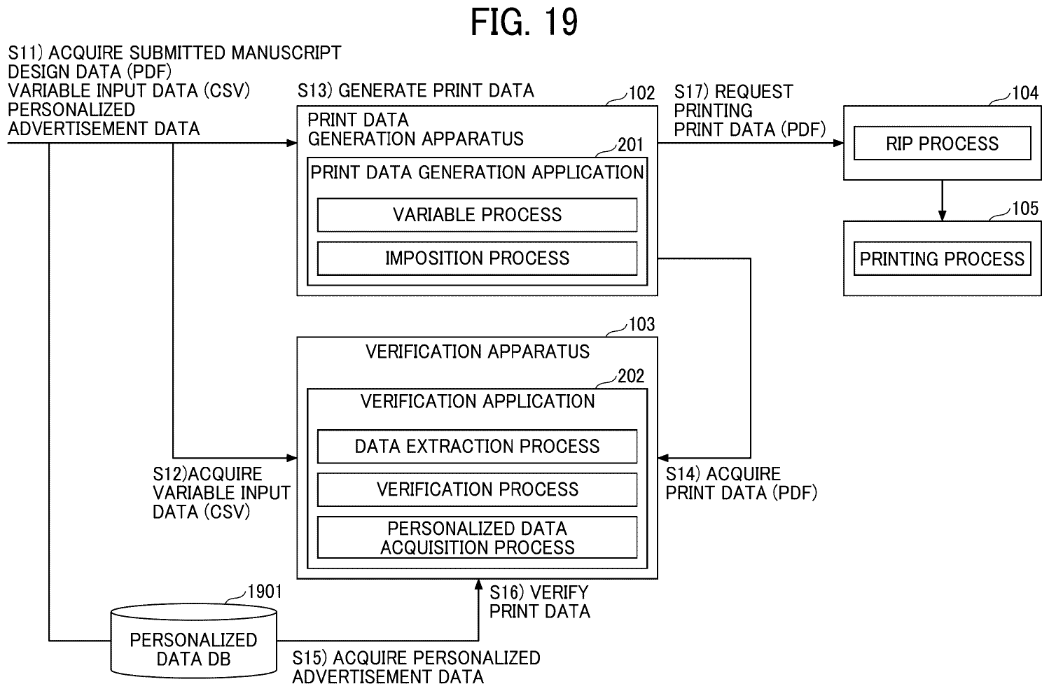

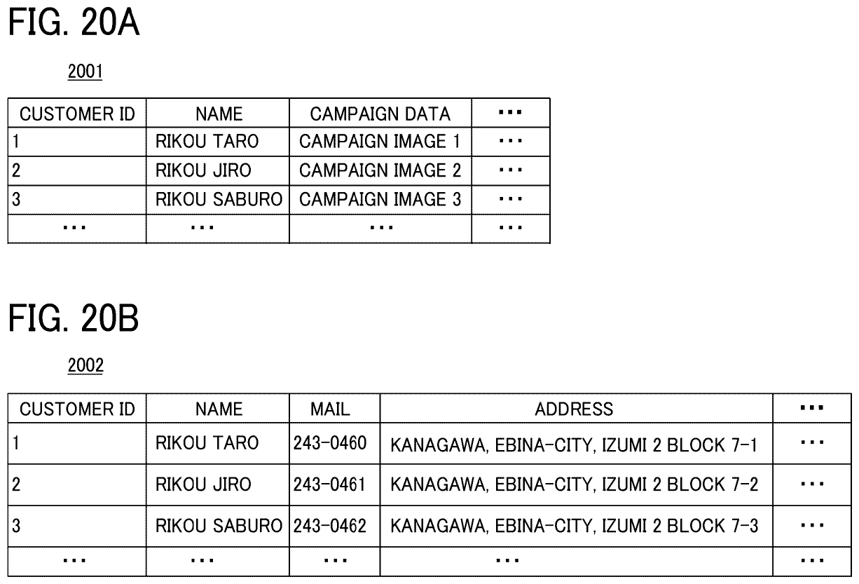

FIG. 19 is a diagram illustrating an overview of the process according to the fourth embodiment of the present disclosure. As illustrated in FIG. 19, in a personalized data database (DB) 1901, for example, personalized advertisement data 2001 illustrated in FIG. 20A is stored. In the personalized advertisement data 2001, for an individual customer to whom a direct mail is sent, campaign data to be printed as texts or images on the direct mail is recorded.

As illustrated in FIG. 20A, the personalized advertisement data 2001 includes pieces of information such as a “CUSTOMER ID,” a “NAME,” and “CAMPAIGN DATA” as data items. The “CUSTOMER ID” is identification information for identifying a customer. The “NAME” is information indicating, for example, the name of the customer. The “CAMPAIGN DATA” is campaign data to be printed as texts or images in a variable area of a direct mail to be sent to an individual customer. As illustrated in FIG. 20A, for example, a campaign image or information for specifying a campaign image that serve as the campaign data is stored.

Variable input data 2002 according to the fourth embodiment includes, for example, a “CUSTOMER ID” as illustrated in FIG. 20B. As illustrated in FIG. 20B, the variable input data 2002 includes pieces of information such as the “CUSTOMER ID,” a “NAME,” a “MAIL,” and an “ADDRESS” as data items. The “CUSTOMER ID” is identification information for identifying a customer, and corresponds to the “CUSTOMER ID” included in the personalized data DB 1901. The “NAME” is information indicating, for example, the name of the customer. The “MAIL” is information indicating the postal code of the customer. The “ADDRESS” is information indicating the address of the customer.

As described above, in the fourth embodiment, the customer (addressee) of the variable input data 2002 and the customer of the personalized data DB 1901 are associated with each other by the “CUSTOMER ID.”

### Overview of Process

As illustrated in FIG. 19, the print data generation apparatus 102 acquires, for example, a submitted manuscript that includes design data (a PDF file) including a variable area, the variable input data 2002, and the personalized advertisement data 2001 (step S11). The verification apparatus 103 acquires variable input data (a CSV file) included in the submitted manuscript (step S12).

The print data generation apparatus 102 generates print data (another PDF file) used for variable printing using the design data (PDF file), the record information included in the variable input data 2002, and the campaign image included in the personalized advertisement data 2001 (step S13).

The verification apparatus 103 acquires the print data (the other PDF file) used for the variable printing generated by the print data generation apparatus 102 (step S14). The verification apparatus 103 also acquires the personalized advertisement data 2001 from the personalized data DB 1901 (step S15).

The verification apparatus 103 also verifies the data read from the variable area included in the acquired print data to check whether any error exists in the data using the acquired personalized advertisement data 2001 and the variable input data 2002 (step S16). For example, the operator uses the verification application 202 installed in the verification apparatus 103 to set a variable area and associate the variable area with data to be verified (verification data). In response to the operation performed by the operator, the verification application 202 executes, for example, a data extraction process to extract data from the variable area included in the print data and a verification process to verify the consistency between the extracted data and the verification data, and outputs a verification result.

In the case where the verification result is determined to be “PASS,” which indicates that there is no issue with the consistency, the print data generation apparatus 102 transmits a print request that includes the generated print data (the other PDF file) to the DFE 104 (step S17).

Through the processes described above, the verification system 1 according to the fourth embodiment verifies print data used for variable printing, which includes a personalized advertisement area where personalized advertisement is printed, to check whether any error exists in the print data before printing is executed.

### Process Flow

The process flow of the verification method according to the fourth embodiment is described below.

### Process Executed by Verification System

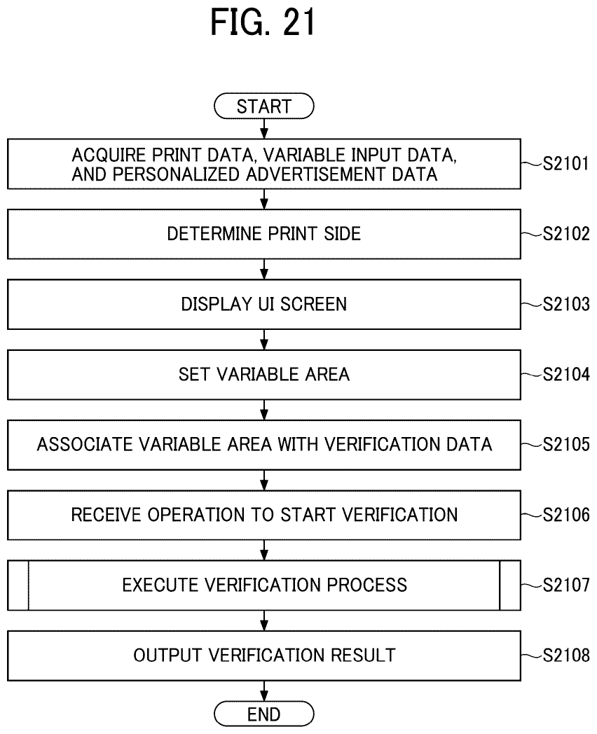

FIG. 21 is a flowchart of the process executed by the verification system 1 according to the fourth embodiment of the present disclosure. The basic contents of the process are substantially the same as those of the process executed by the verification system 1 according to the embodiment described with reference to FIG. 5, and thus a detailed description thereof is omitted below.

In step S2101, the verification apparatus 103 acquires the print data generated by the print data generation apparatus 102, the variable input data 2002 used for generating the print data, and the personalized advertisement data 2001.

In step S2102, the verification apparatus 103 determines the print side (single-sided or double-sided). For example, the verification apparatus 103 displays a selection screen for selecting whether the print data is print data in a double-sided printing format or print data in a single-sided printing format, and determines the print side according to a selection operation performed by the operator.

In step S2103, the verification apparatus 103 displays a UI screen in which a preview image when printing is executed based on the acquired print data is displayed. The verification apparatus 103 displays, for example, the UI screen 600 as illustrated in FIG. 6.

In step S2104, the verification apparatus 103 sets a variable area. For example, the verification apparatus 103 receives an operation to designate a variable area performed by the operator on the preview image displayed on the UI screen 600.

In step S2105, the verification apparatus 103 associates the set variable area with the verification data. For example, in the area data association table 630 displayed on the UI screen 600, the verification apparatus 103 receives a setting of verification data to be associated with an individual variable area through the pull-down menu of the “DATA” or the like.

In steps S2106 and S2107, in response to receiving an operation to start verification, the verification apparatus 103 executes a verification process to verify the consistency between the data read form the variable area included in the print data and the verification data.

In step S2108, the verification apparatus 103 outputs a verification result of the verification process.

### Verification Process

At this point, a case in which the verification process executed by the verification apparatus 103 in step S2107 of FIG. 21 is described below.

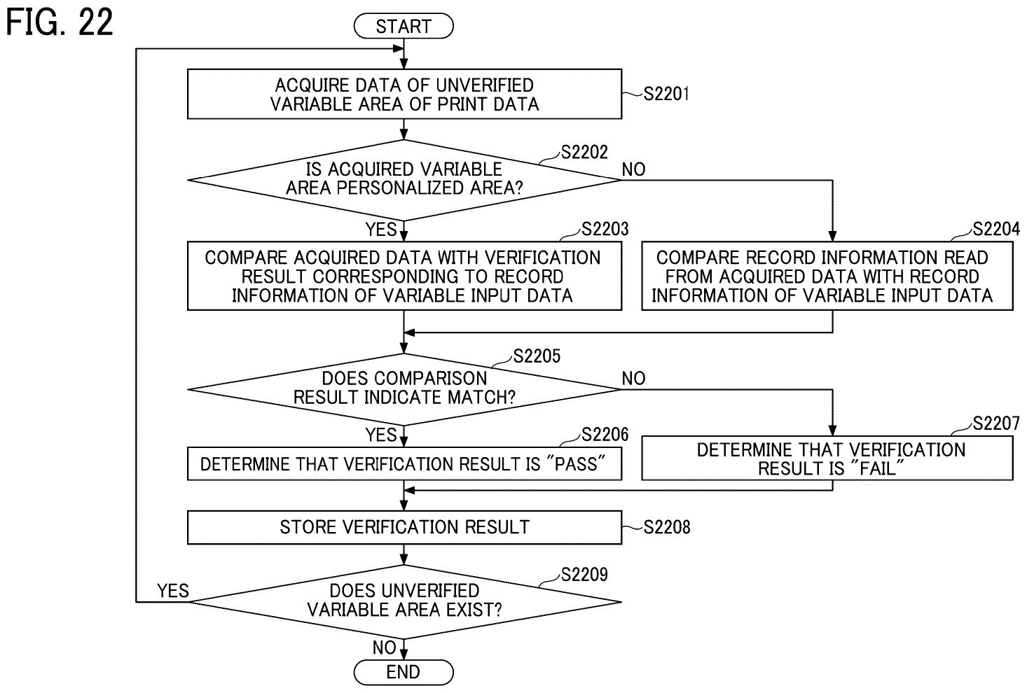

FIG. 22 is a flowchart of the verification process according to the fourth embodiment of the present disclosure. This process is given by way of example as the verification process executed by the verification apparatus 103 in step S2107 of FIG. 21. The basic contents of the process are substantially the same as those of the process executed by the verification system 1 according to the first embodiment described with reference to FIG. 9, and thus a detailed description thereof is omitted below.

In step S2201, the verification apparatus 103 acquires (reads) data from an unverified variable area included in the print data.

In step S2202, the verification apparatus 103 determines whether the variable area from which the data is acquired is a personalized advertisement area. In the case where the variable area from which the data is acquired is determined to be a personalized advertisement area, the process executed by the verification apparatus 103 proceeds to step S2203. On the other hand, in the case where the variable area from which the data is acquired is determined not to be a personalized advertisement area, the process executed by the verification apparatus 103 proceeds to step S2204.

When the process proceeds to step S2203, the verification apparatus 103 compares the data acquired from the variable area with the verification data corresponding to the record information included in the variable input data 2002.

For example, when the variable area “AREA 1” is set as the personalized advertisement area in the area data association table 630 on the UI screen 600 illustrated in FIG. 6, the “CUSTOMER ID” is set to the “DATA” using the pull-down menu or the like. In this case, if the record information of the variable input data 2002 is a customer ID “1” in step S2203, a “CAMPAIGN IMAGE 1” corresponding to the customer ID “1” in the personalized advertisement data 2001 is the verification data.

On the other hand, when the process proceeds to step S2204, the verification apparatus 103 compares the record information read from the acquired data with the record information included in the variable input data.

In step S2205, the verification apparatus 103 determines whether the comparison result determined in step S2203 or S2204 indicates a match. In the case where the comparison result is determined to indicate a match, the process executed by the verification apparatus 103 proceeds to step S2206. On the other hand, in the case where the comparison result is determined not to indicate a match, the process executed by the verification apparatus 103 proceeds to step S2207.

When the process proceeds to step S2206, the verification apparatus 103 determines that the verification result is “PASS” (no issue). On the other hand, when the process proceeds to step S2207, the verification apparatus 103 determines that the verification result is “FAIL” (an issue). In step S2208, the verification apparatus 103 stores the verification result in, for example, the storage unit 411.

In step S2209, the verification apparatus 103 determines whether any unverified variable area exists. In the case where an unverified variable area is determined to exist, the process executed by the verification apparatus 103 returns to step S2201. On the other hand, in the case where an unverified variable area is determined not to exist, the process of FIG. 22 executed by the verification apparatus 103 ends.

Through the processes of FIGS. 21 and 22, the verification system 1 according to the fourth embodiment can also verify print data used for variable printing to check whether any error exists in image data included in the print data before printing is executed.

As described above, according to the embodiments of the present disclosure, print data used for variable printing can be verified to check whether any error exists in the print data before printing is executed.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The functional configuration of the verification apparatus 103 illustrated in FIG. 4 is given by way of example. The functional units of the verification apparatus 103 may be distributed over multiple apparatuses. Further, some or all of the functional units of the verification apparatus 103 may be included in another apparatus such as the print data generation apparatus 102 or the DFE 104. Furthermore, the functional units of the verification apparatus 103 may be implemented by, for example, one or more programs executed by a virtual machine on a cloud.

Aspects of the present disclosure are, for example, as follows.

The aspects of the present disclosure relate to a verification apparatus, a verification system, a verification method, and a non-transitory recording medium.
According to Aspect 1, a verification apparatus includes:
a print data acquisition unit that acquires print data generated from design data that includes a variable area and first record information included in variable input data;
a verification unit that verifies data read from the variable area included in the print data to check whether any error exists in the data based on the first record information included in the variable input data; and
an output unit that outputs a verification result determined by the verification unit.
According to Aspect 2, in the verification apparatus according to Aspect 1, the data read from the variable area included in the print data is second record information, and the verification unit verifies consistency between the first record information included in the variable input data and the second record information read from the variable area included in the print data.
According to Aspect 3, the verification apparatus according to Aspect 2 further includes a reading unit that reads the second record information from image data of the variable area included in the print data.
According to Aspect 4, in the verification apparatus according to Aspect 3, the image data of the variable area includes a two-dimensional code representing the second record information.
According to Aspect 5, in the verification apparatus according to Aspect 3, the image data of the variable area includes a character image representing the second record information.
According to Aspect 6, the verification apparatus according to any one of Aspects 1 to 5 further includes an information acquisition unit that acquires the first record information corresponding to the variable area from the variable input data.
According to Aspect 7, the verification apparatus according to any one of Aspects 1 to 6 further includes a display control unit that controls a display to display a display screen including a preview image when printing is executed based on the print data.
According to Aspect 8, in the verification apparatus according to Aspect 7, the preview image includes a front side image to be printed on a front side of a sheet and a back side image to be printed on a back side of the sheet when the printing is executed on the sheet based on the print data.
According to Aspect 9, the verification apparatus according to Aspect 7 or 8 further includes an operation reception unit that receives, on the display screen, an operation to designate the variable area from which the second record information is read.
According to Aspect 10, in the verification apparatus according to Aspect 9, the display control unit controls the display to display on the display screen a user interface used for associating the variable area with the first record information included in the variable input data.
According to Aspect 11, in the verification apparatus according to Aspect 9 or 10, the preview image includes images of multiple printed matters that are imposed, and the verification apparatus further includes a setting control unit that reflects a setting of the variable area set for an image of one printed matter, among the images of the multiple printed matters that are imposed, to the images of the rest of the multiple printed matters.
According to Aspect 12, in the verification apparatus according to Aspect 11, the display control unit can control the display to display a setting screen for receiving a setting of imposition.
According to Aspect 13, in the verification apparatus according to Aspect 12, the setting of the imposition includes information indicating at least one of the number of impositions, positions of the impositions, and an order of the impositions.
According to Aspect 14, in the verification apparatus according to any one of Aspects 1 to 13, in the case that an error is detected in the data read from the variable area included in the print data, the output unit outputs the verification result that indicates an error area where the error exists.
According to Aspect 15, the verification apparatus according to any one of Aspects 1 to 14 further includes an inference unit that, in the case that an error is detected in the data read from the variable area included in the print data, infers a cause of the error, and the output unit outputs the verification result that includes an inference result obtained by the inference unit inferring the cause of the error.
According to Aspect 16, in the verification apparatus according to Aspect 1, the verification unit verifies consistency between the data read from the variable area included in the print data and verification data corresponding to the first record information included in the variable input data.
According to Aspect 17, a verification system includes:
a print data acquisition unit that acquires print data generated from design data that includes a variable area and record information included in variable input data;
a verification unit that verifies data read from the variable area included in the print data to check whether any error exists in the data based on the record information included in the variable input data; and
an output unit that outputs a verification result determined by the verification unit.
According to Aspect 18, a verification method includes:
acquiring print data generated from design data that includes a variable area and record information included in variable input data;
verifying data read from the variable area included in the print data to check whether any error exists in the data based on the record information included in the variable input data; and
outputting a verification result determined based on the verification.
According to Aspect 19, a non-transitory recording medium stores a plurality of program codes which, when executed by one or more processors, causes the one or more processors to perform the method according to Aspect 18.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

1. A verification apparatus comprising circuitry configured to:
acquire print data generated from design data including a variable area and first record information included in variable input data;
verify data read from the variable area included in the print data to check whether any error exists in the data based on the first record information included in the variable input data; and
output a verification result based on the verification.

2. The verification apparatus according to claim 1, wherein
the data read from the variable area included in the print data is second record information, and
the circuitry is configured to verify consistency between the first record information included in the variable input data and the second record information read from the variable area included in the print data.

3. The verification apparatus according to claim 2, wherein the circuitry is further configured to read the second record information from image data of the variable area included in the print data.

4. The verification apparatus according to claim 3, wherein the image data of the variable area includes a two-dimensional code representing the second record information.

5. The verification apparatus according to claim 3, wherein the image data of the variable area includes a character image representing the second record information.

6. The verification apparatus according to claim 1, wherein the circuitry is configured to acquire the first record information corresponding to the variable area from the variable input data.

7. The verification apparatus according to claim 1, wherein the circuitry is further configured to control a display to display a display screen including a preview image when printing is executed based on the print data.

8. The verification apparatus according to claim 7, wherein the preview image includes a front side image to be printed on a front side of a sheet and a back side image to be printed on a back side of the sheet when the printing is executed on the sheet based on the print data.

9. The verification apparatus according to claim 7, wherein the circuitry is further configured to receive, on the display screen, an operation to designate the variable area from which the second record information is read.

10. The verification apparatus according to claim 9, wherein the circuitry is configured to control the display to display on the display screen a user interface used for associating the variable area with the first record information included in the variable input data.

11. The verification apparatus according to claim 9, wherein the preview image includes images of a plurality of printed matters that are imposed, and
the circuitry is further configured to reflect a setting of the variable area set for an image of one printed matter, among the images of the plurality of printed matters that are imposed, to the images of a rest of the plurality of printed matters.

12. The verification apparatus according to claim 11, wherein the circuitry is configured to control the display to display a setting screen for receiving a setting of imposition.

13. The verification apparatus according to claim 12, wherein the setting of the imposition includes information indicating at least one of a number of impositions, positions of the impositions, or an order of the impositions.

14. The verification apparatus according to claim 1, wherein, in a case that an error is detected in the data read from the variable area included in the print data, the circuitry is configured to output the verification result indicating an error area where the error exists.

15. The verification apparatus according to claim 1, wherein, in a case that an error is detected in the data read from the variable area included in the print data, the circuitry is further configured to infer a cause of the error and output the verification result including an inference result obtained by inferring the cause of the error.

16. The verification apparatus according to claim 1, wherein the circuitry is configured to verify consistency between the data read from the variable area included in the print data and verification data corresponding to the first record information included in the variable input data.

17. A verification system comprising circuitry configured to:
acquire print data generated from design data including a variable area and record information included in variable input data;
verify data read from the variable area included in the print data to check whether any error exists in the data based on the record information included in the variable input data; and
output a verification result based on the verification.

18. A verification method comprising:
acquiring print data generated from design data including a variable area and record information included in variable input data;
verifying data read from the variable area included in the print data to check whether any error exists in the data based on the record information included in the variable input data; and
outputting a verification result based on the verification.

19. A non-transitory recording medium storing a plurality of program codes which, when executed by one or more processors, causes the one or more processors to perform the method according to claim 18.
